(19) United States
(12) Patent Application Publication
(10) Pub. No.: US 2015/0083804 A1
(43) Pub. Date: Mar. 26, 2015

(54) SYSTEM AND METHOD FOR A SECURE ACCESS CARD

(71) Applicant: William Chorba, Boynton Beach, FL (US)

(72) Inventor: William Chorba, Boynton Beach, FL (US)

(21) Appl. No.: 14/035,894

(22) Filed: Sep. 24, 2013

(51) Int. Cl. G07C 9/00; G06K 19/00

(52) U.S. Cl. CPC G07C 9/00; G06K 19/00
USPC 235/382.5; 235/487

(57) ABSTRACT

A secure access card according to one example embodiment includes an exterior surface and a communication portion connected to the exterior surface. Multiple embodiments provide that the exterior surface includes an individual identification portion. Embodiments include those in which the exterior surface has a first color, and when the communication portion receives a signal indicating that the secure access card is deactivated, the exterior surface has a second color. Embodiments also include those in which the exterior surface displays an image when the communication portion receives a signal indicating that the secure access card is deactivated.

### CROSS-REFERENCE TO RELATED APPLICATIONS

None.

### BACKGROUND

1. Field of the Disclosure

The present invention relates to systems and methods for secure access cards.

2. Description of the Related Art

In today's world, identification badges and access badges are used in a multitude of various settings and environments to confirm the identity of individuals and allow access to secured areas. Government offices, hospitals and corporate facilities are just a few of the many settings in which identification badges and access badges are typically used. In addition, combination identification and access badges are often used both to confirm the identity of individuals and to allow access to secured areas within a facility.

However, the security of facilities can be compromised when unauthorized individuals utilize identification and access badges to gain access to the facilities or to impersonate authorized individuals. For example, if an unauthorized individual obtains the typical combination identification and access badge, even if the badge is deactivated, the unauthorized individual can still use the external appearance of the badge as an identification card to gain access to secured areas and to impersonate an authorized individual. Accordingly, it will be appreciated that a secure access card that reduces the ability of unauthorized individuals to gain access to facilities or to impersonate authorized individuals is desired.

### SUMMARY

A secure access card according to one example embodiment includes an exterior surface and a communication portion connected to the exterior surface. The exterior surface has an individual identification portion and a first color. When the communication portion receives a signal indicating that the secure access card is deactivated, the exterior surface has a second color.

A secure access card according to another example embodiment includes an exterior surface and a communication portion connected to the exterior surface. The exterior surface has an individual identification portion. When the communication portion receives a signal indicating that the secure access card is deactivated, the exterior surface displays an image.

A secure access card system according to one example embodiment includes a secure access card and a transmitter device. The secure access card has an exterior surface and a communication portion connected to the exterior surface, and the exterior surface has an individual identification portion. The transmitter device is able to communicate with the communication portion of the secure access card. When the communication portion of the secure access card receives a signal indicating that the secure access card is deactivated, the exterior surface displays an image.

A secure access card system according to another example embodiment includes a secure access card and a transmitter device. The secure access card has an exterior surface and a communication portion connected to the exterior surface, and the exterior surface has an individual identification portion and a first color. The transmitter device is able to communicate with the communication portion of the secure access card. When the communication portion of the secure access card receives a signal indicating that the secure access card is deactivated, the exterior surface has a second color.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a schematic view of a secure access card system according to multiple embodiments and alternatives;

FIG. 2 is a front cross sectional view of the secure access card illustrated in FIG. 1;

FIG. 3 is a front elevation view of a secure access card according to multiple embodiments and alternatives.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, process and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense and the scope of the invention is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings and mountings. In addition, the terms “connected” and “coupled” and variations thereof are not restricted to physical or mechanical connections or couplings.

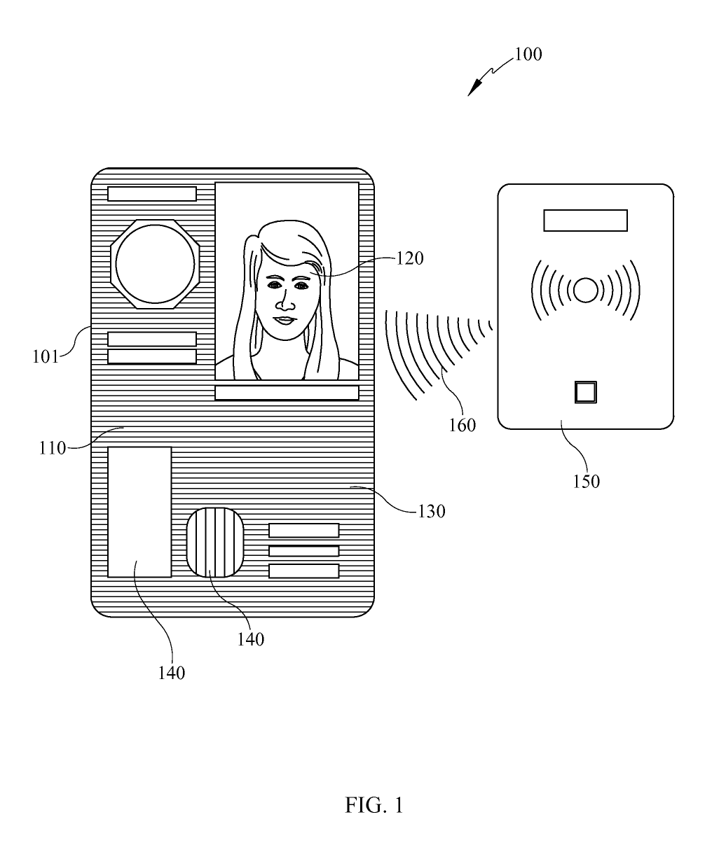

Turning now to the drawings, and more particularly to FIG. 1, an example embodiment of a secure access card system 100 is illustrated. The secure access card system 100 includes a secure access card 101 and a transmitter device 150. The secure access card 101 has an exterior surface 110 with an individual identification portion 120. In addition, the secure access card 101 also has a communication portion 140 connected to the exterior surface 110.

The exterior surface 110 of the secure access card 101 may extend over any of the surfaces or edges of the secure access card 101, such as a front surface of the secure access card 101, a rear surface of the secure access card 101, a side surface of the secure access card 101, a side edge of the secure access card 101, front and rear surfaces of the secure access card 101 or any combination thereof, for example. In multiple embodiments, the exterior surface 110 is manufactured from a material that can change color. In some embodiments, the exterior surface 110 is manufactured from a material that can change color when stimulated by heat at a predetermined temperature. In certain embodiments, the exterior surface 110 of the secure access card 101 is manufactured from a polymer, such as a thermoplastic or duroplastic, for example.

The individual identification portion 120 of the exterior surface 110 may include a variety of information about an individual. In some embodiments, for example, the identification portion 120 may include an individual's name, physical description, photograph, position, department or access level. In addition, in multiple embodiments of the secure access card 101, the exterior surface 110 has a first color 130. The first color 130 of the exterior surface 110 may be any color. In some embodiments, for example, the first color 130 may be white, yellow, red, orange, green, blue, purple, brown or black.

The communication portion 140 of the secure access card 101 may include any mechanism that can communicate with the transmitter device 150, such as a smart card, microchip, barcode or magnetic stripe, for example. The transmitter device 150 may include any mechanism that can communicate with the communication portion 140, such as a proximity card reader, smart card reader, bar code reader or magnetic card reader, for example. Communication between the communication portion 140 and the transmitter device 150 may be established via a wired or wireless connection as is known in the art. The transmitter device 150 may include a single transmitter unit or multiple transmitter units in communication with each other. Each transmitter unit may include one or more processors that include, or are communicatively coupled to, memory having computer executable storage instructions. The processor(s) may execute the computer executable storage instructions, causing the transmitter unit(s) to perform their function.

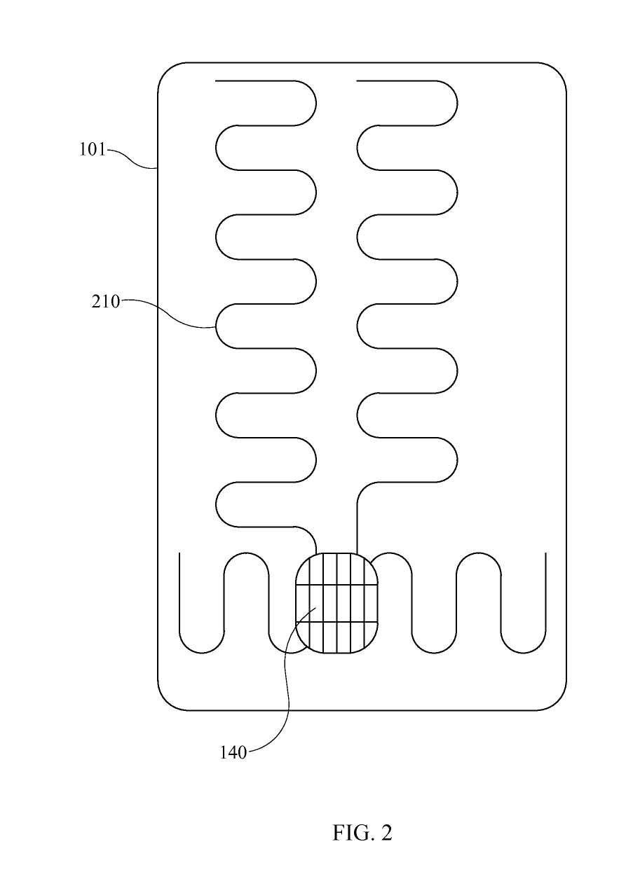

With reference to FIG. 2, in some embodiments of the secure access card 101, the communication portion 140 is connected to wires 210. In certain embodiments, wires 210 conduct heat, which may radiate to the exterior surface 110.

Returning to FIG. 1, in multiple embodiments, the secure access card system 100 may be used to confirm the identity of an individual and to allow access to secured areas within a facility. In some embodiments, the identification portion 120 confirms the identity of an individual. In certain embodiments, for example, a photograph of the individual may confirm the individual's identity. In some embodiments, the communication portion 140 communicates with the transmitter device 150 to allow access to secured areas within a facility. The facility may be any facility with secured areas, such as a hospital, government office or corporate building, for example. In certain embodiments, the communication portion 140 may communicate with the transmitter device 150 to unlock doors to allow access to the secured areas. The secured areas may include storage cabinets with controlled substances, areas with proprietary business information or technology, control rooms or confidential research areas, for example.

In multiple embodiments, the secure access card system 100 sends a signal 160 indicating that the secure access card 101 is deactivated. In some embodiments, the secure access card system 100 may send the signal 160 from the transmitter device 150 to the communication portion 140 that the secure access card 101 is deactivated. In some embodiments, the secure access card system 100 may send the signal 160 when the secure access card 101 has been lost or stolen or when access privileges of an owner of the secure access card 101 have been revoked. In certain embodiments, for example, the access privileges of the card owner may be revoked if the card owner's position or employment at a facility secured by the secure access card system 100 has been terminated.

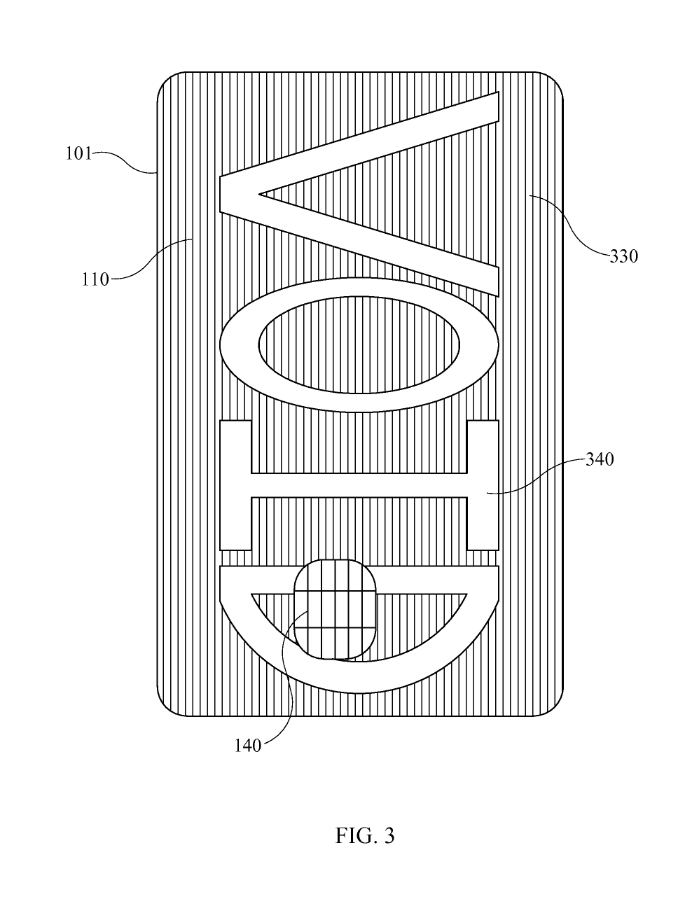

Turning to FIG. 3, in multiple embodiments, the exterior surface 110 changes from the first color 130 (shown in FIG. 1) to a second color 330 when the communication portion 140 receives the signal 160 (shown in FIG. 1) indicating that the secure access card 101 is deactivated. The second color 330 may be any color. In some embodiments, for example, the second color 330 may be white, yellow, red, orange, green, blue, purple, brown or black. The changed exterior surface 110 with the second color 330 may obscure the visibility of the identification portion 120 (shown in FIG. 1) and prevent an unauthorized individual from using the secure access card 101 to gain access to a secure facility or from impersonating an authorized individual.

In certain embodiments, the exterior surface 110 has the second color 330 when stimulated by heat at a predetermined temperature. In some embodiments, the communication portion 140 heats to the predetermined temperature when the communication portion 140 receives the signal 160 (shown in FIG. 1) indicating that the secure access card 101 is deactivated. In such embodiments, the heat from the communication portion 140 may change the exterior surface 110 from the first color 130 (shown in FIG. 1) to the second color 330. In certain embodiments, the wires 210 (shown in FIG. 2) conduct the heat, which radiates to the exterior surface 110. In such embodiments, the radiated heat may change the exterior surface 110 from the first color 130 (shown in FIG. 1) to the second color 330.

In multiple embodiments, the exterior surface 110 displays an image 340 when the communication portion 140 receives the signal 160 (shown in FIG. 1) indicating that the secure access card 101 is deactivated. In some embodiments, for example, the image is the word “VOID”. The changed exterior surface 110 with the image 340 may obscure the visibility of the identification portion 120 (shown in FIG. 1) and prevent an unauthorized individual from using the secure access card 101 to gain access to a secure facility or from impersonating an authorized individual.

In certain embodiments, the exterior surface 110 displays the image 340 when stimulated by heat at a predetermined temperature. In some embodiments, the communication portion 140 heats to the predetermined temperature when the communication portion 140 receives the signal 160 (shown in FIG. 1) indicating that the secure access card 101 is deactivated. In such embodiments, the heat from the communication portion 140 may change the exterior surface 110 to display the image 340. In certain embodiments, the wires 210 (shown in FIG. 2) conduct the heat, which radiates to the exterior surface 110. In such embodiments, the radiated heat may change the exterior surface 110 to display the image 340.

It will be appreciated that the secure access card system 100 reduces the ability of unauthorized individuals to gain access to facilities or to impersonate authorized individuals. Thus, the secure access card system 100 increases and improves security in facilities. Further, the secure access card system 100 provides such benefits in an efficient and cost-effective manner.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. A secure access card, comprising:
an exterior surface having an individual identification portion and a first color; and
a communication portion connected to the exterior surface,
wherein the exterior surface has a second color when the communication portion receives a signal indicating that the secure access card is deactivated.

2. The secure access card of claim 1, wherein the exterior surface has the second color when stimulated by heat at a predetermined temperature and wherein the communication portion heats to the predetermined temperature when the communication portion receives the signal indicating that the secure access card is deactivated.

3. The secure access card of claim 1, wherein the exterior surface with the second color obscures visibility of the identification portion.

4. The secure access card of claim 1, further comprising a front surface and a rear surface, wherein the exterior surface extends over the front surface of the secure access card and the rear surface of the secure access card.

5. The secure access card of claim 1, wherein the exterior surface is made from material comprising a polymer.

6. The secure access card of claim 1, wherein the communication portion is connected to wires that conduct heat to the exterior surface.

7. The secure access card of claim 1, wherein the communication portion receives the signal indicating that the secure access card is deactivated from a transmitter device.

8. The secure access card of claim 1, wherein the exterior surface displays an image when the communication portion receives the signal indicating that the secure access card is deactivated.

9. The secure access card of claim 8, wherein the image is the word “VOID”.

10. A secure access card, comprising:
an exterior surface having an individual identification portion; and
a communication portion connected to the exterior surface,
wherein the exterior surface displays an image when the communication portion receives a signal indicating that the secure access card is deactivated.

11. The secure access card of claim 10, wherein the exterior surface displays the image when stimulated by heat at a predetermined temperature and wherein the communication portion heats to the predetermined temperature when the communication portion receives the signal indicating that the secure access card is deactivated.

12. The secure access card of claim 10, wherein the image obscures visibility of the identification portion.

13. The secure access card of claim 10, further comprising a front surface and a rear surface, wherein the exterior surface extends over the front surface of the secure access card and the rear surface of the secure access card.

14. The secure access card of claim 10, wherein the exterior surface is made from material comprising a polymer.

15. The secure access card of claim 10, wherein the communication portion is connected to wires that conduct heat to the exterior surface.

16. The secure access card of claim 10, wherein the communication portion receives the signal indicating that the secure access card is deactivated from a transmitter device.

17. The secure access card of claim 10, wherein the image is the word “VOID”.

18. A secure access card system, comprising:
a secure access card having an exterior surface and a communication portion connected to the exterior surface, the exterior surface including an individual identification portion; and
a transmitter device able to communicate with the communication portion of the secure access card;
wherein the exterior surface of the secure access card displays an image when the communication portion receives a signal indicating that the secure access card is deactivated.

19. The secure access card system of claim 18, wherein the exterior surface displays the image when stimulated by heat at a predetermined temperature and wherein the communication portion heats to the predetermined temperature when the communication portion receives the signal indicating that the secure access card is deactivated.

20. The secure access card system of claim 18, wherein the image obscures visibility of the identification portion.

21. A secure access card system, comprising:
a secure access card having an exterior surface and a communication portion connected to the exterior surface, the exterior surface including an individual identification portion and a first color; and
a transmitter device able to communicate with the communication portion of the secure access card;
wherein the exterior surface of the secure access card has a second color when the communication portion receives a signal indicating that the secure access card is deactivated.
